(19) United States
(12) Patent Application Publication
(10) Pub. No.: US 2008/0223221 A1
(43) Pub. Date: Sep. 18, 2008

(54) Steam generator and steam chamber oven insert for converting conventional home oven to steam injected bread baking oven

(76) Inventor: Mark J. Schimpf, Allendale, NJ (US)

Correspondence Address: LAW OFFICES OF MITCHELL P. NOVICK, 66 PARK STREET, MONTCLAIR, NJ, 07042, US

(21) Appl. No.: 11/716,737

(22) Filed: Mar. 12, 2007

(51) Int. Cl. A47J 27/04

(52) U.S. Cl. 99/324

(57) ABSTRACT

The concept of the invention is to spray a steam mist on loaves of unbaked bread while they are baking. The basic items comprising the invention are a baking stone on which loaves of bread rest, a lid which rests on the baking stone. Further, the lid has a relatively small opening for receiving steam from a steam generator which produces a superheated steam into the chamber formed by the lid and the baking stone. Steam is injected only at the beginning of the baking process and the lid is removed approximately ¼ to ⅓ of the way through the baking process. The operator pulls a trigger on a steam generator and a stream of superheated steam is released into the steam chamber. Thus, the operator controls the volume of steam injected into the chamber.

### BACKGROUND OF THE INVENTION

### 1. Field of the Invention

The present invention generally involves the field of technology pertaining to spraying a steam mist into an oven chamber immediately after unbaked bread loaves are added to the oven chamber. Injecting steam at this point retards gelatinization of the loaf surface there by providing a good “spring” while in the oven. Loaves of bread baked with the steam injection device are larger and airier than others not using this device or method. Further, steam injection at the beginning of the baking process will insure that the bread will have a thin, crispy crust when the baking process is through.

One of the distinctions between a professional bread baking oven from the typical ovens used in homes is that venting of steam introduced at the start of baking can be controlled from the professional baking oven but the home baker has no control over the venting of steam from the home oven.

When a trigger associated with the steam generator of this invention is pulled a stream of superheated steam is released into a steam chamber. Thus, the operator or baker controls the volume of steam injected into the steam chamber.

With this invention, steam is injected at the early phase of the baking process and the steam chamber lid is removed from approximately ⅓ of the way through the baking process. The atmosphere in the oven during the final baking stages should be dry which gives a thin, crispy crust and which caramelizes the sugars on the surface. Removing the steam chamber lid provides the home baker with control of the venting of the steam introduced at the start of baking.

### SUMMARY OF THE INVENTION

The basic idea of the invention is to spray a steam mist on loaves of unbaked bread at the start of baking. The items comprising the invention are, essentially, a baking stone on which loaves of bread rest, a lid which rests on the baking stone and a steam generator. The lid has a relatively small opening or aperture for receiving steam from a steam generator which produces a superheated steam into the chamber formed by the lid and the baking stone.

Steam is injected at the beginning of the baking process and the lid should be removed roughly ¼ to ⅓ of the way through the baking process.

The baker or operator pulls a trigger on a steam generator and a stream of superheated steam is released into the steam chamber. Thus, the operator controls the volume of steam injected into the chamber.

Briefly summarizing the invention, the subject matter relates to a baking stone with cover with an aperture in the cover and a trigger operated steam generator with a nozzle. The nozzle can be inserted into the aperture to provide a moisture atmosphere for a portion of the baking cycle.

It is, therefore, an object of the present invention to provide a bread making device into which a steam mist is sprayed on loaves of unbaked bread while they are baking.

It is another object of the invention to provide such a bread baker wherein loaves of bread to be baked rest on a baking stone.

It is yet a further object of the invention to provide such a bread baking device wherein an oven insert lid rests on the baking stone.

It is still a further object of the invention to provide a relatively small opening or aperture in the lid for receiving steam from a steam generator which produces a superheated steam into the chamber formed by the lid and the baking stone.

It is still a further object of the invention to provide an oven insert lid which lid should be removed roughly ¼ to ⅓ of the way through the baking process.

It is still a further object of the invention to provide a baking stone with cover and an aperture in the cover and a trigger operated steam generator with a nozzle.

It is still a further object of the invention to provide the cover with an aperture and a trigger operated steam generator with a nozzle.

It is still a further object of the invention to provide a nozzle which can be inserted into the aperture to provide a moisture atmosphere for a portion of the baking cycle.

These and other objects, features and advantages of the invention shall become apparent from the following detailed description of a preferred embodiment thereof when taking in conjunction with the drawings wherein like referenced characters refer to corresponding parts in the several views.

### BRIEF DESCRIPTION OF THE DRAWINGS

FIG. 1 is a pictorial view of the steam generator, steam generator lid and baking stone.

FIG. 2 is the same as FIG. 1 but showing the steam generator nozzle inserted through an aperture in the lid.

FIG. 3 is the same as FIG. 1 but showing a fill cup resting on a steam chamber lid, a steam chamber, and a baking stone under and supporting the steam chamber lid.

FIG. 4 is a view of the steam chamber with the lid removed and several loaves of pre-baked bread resting on the baking stone.

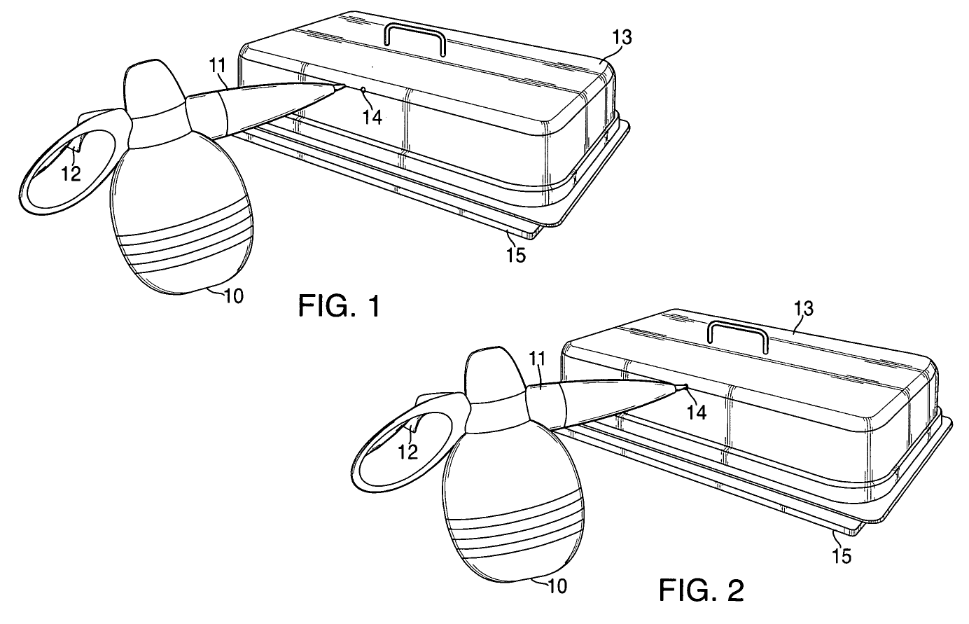

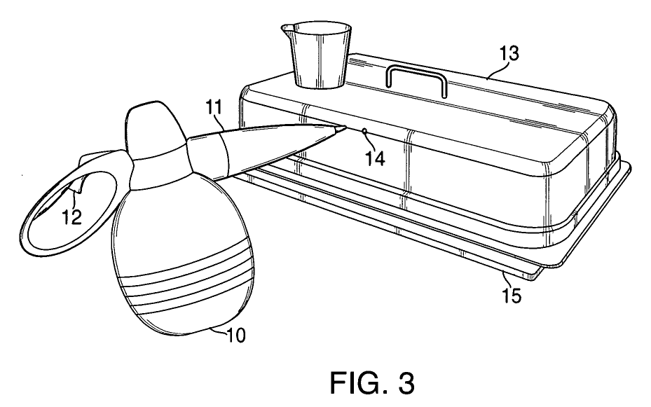

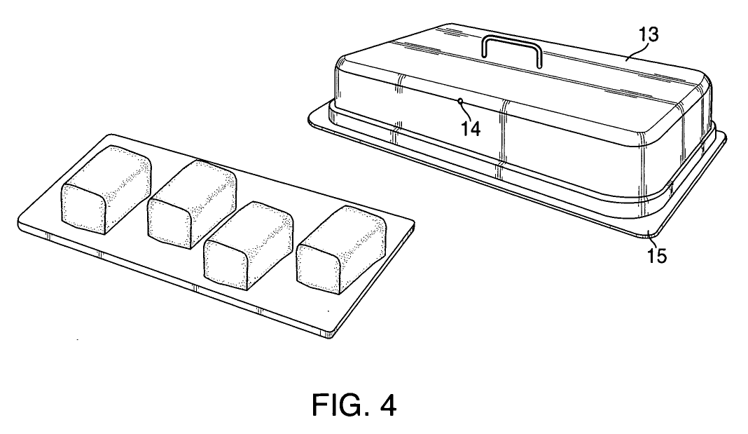

### DETAILED DESCRIPTION OF THE PREFERRED EMBODIMENT

A bread baking device to be used with a standard home oven for baking larger and airier bread having a thin, crispy crust when baked through will now be described with a reference to the drawings.

The basic elements of this steam generator and injecting device comprises a baking stone, a lid to be placed on the stone when bread is being baked, an aperture through one side of the lid for receiving a steam nozzle associated with the steam generator, and a fill cup for adding water into the steam generator when steam is to be produced.

A trigger associated with the steam generator is pulled to release a steam stream into the steam chamber thus allowing the operator to control the volume of steam injected into the chamber.

The steam generated is only injected at the beginning of the bread baking process and the lid is removed approximately one-third of the way through the baking process giving the baker control of the venting of the steam. All four figures depict a steam generator 10 having a steam nozzle 11, and a trigger 12 for releasing steam from steam generator 10 and into a lid 13 having at least one aperture 14 there through for receiving nozzle 11 when it is desired to steam loaves of bread which are resting on a baking stone 15 in an oven prior to and during at least a portion of the actual bread baking time.

### OPERATION OF THE INVENTION

The baking stone is loaded with loaves to be baked after the stone and the lid are preheated for a desired period of time, usually forty-five-sixty minutes. The lid is then placed over the loaves and the steam nozzle is placed in the steam generator. Steam from the steam generator is then injected by means of the nozzle, through the aperture formed through the lid and into the steam chamber formed by the lid and stone. Steam is injected into the steam chamber by means of depressing the trigger associated with the steam generator. The oven door is now closed. The steam chamber lid is removed five-fifteen minutes later and the bread continues to bake without the lid.

Though the invention has been described and illustrated with reference to a preferred embodiment thereof, those skilled in the art will appreciate the various changes and modifications in shape, size, composition and arrangement of parts may be resorted to without departing from the spirit of the invention or scope of the subjoined claims.

What is claimed is:

1. A steam chamber and steam generator for injecting steam into the steam chamber which contains bread to be baked comprising:
a) A baking stone on which loaves of bread to be baked rest;
b) A lid resting on said baking stone;
c) An aperture through said lid for receiving steam from a steam generator; and,
d) A nozzle for injecting steam into the steam chamber for providing a moist atmosphere for the baking bread.

2. The invention as claimed in claim 1 wherein said nozzle is inserted into said aperture for injecting steam from said steam generator into said steam chamber.

3. The invention as claimed in claim 2 wherein a trigger associated with said steam generator is pulled to release steam from the steam generator through said nozzle and through said aperture and into said steam chamber for providing a moist atmosphere for the baking bread.
